(19) United States
(12) Patent Application Publication
(10) Pub. No.: US 2026/0226847 A1
(43) Pub. Date: Aug. 6, 2026

(54) PITCH-SETTING DEVICE FOR A VARIABLE STATOR VANE

(71) Applicant: SAFRAN, PARIS (FR)

(72) Inventors: William Henri Joseph RIERA, MOISSY CRAMAYEL (FR); Frederic TONG-YETTE, MOISSY CRAMAYEL (FR); Simon Pierre Michel MARTIN, MOISSY CRAMAYEL (FR)

(21) Appl. No.: 19/152,302

(22) PCT Filed: Jan. 24, 2024
(86) PCT No.: PCT/FR2024/050099

§ 371 Date: Sep. 4, 2025

(30) Foreign Application Priority Data
Feb. 1, 2023 (FR) FR2300940

(51) Int. Cl. F01D 17/16; B64D 27/10

(52) U.S. Cl. CPC F01D 17/16; B64D 27/10; F05D 2240/12

(57) ABSTRACT

A device for setting the pitch of a vane for a turbomachine, the device including a vane that is pivotable in a first direction and includes a leading edge, a trailing edge and a base which has an opening; a fin that includes a leading edge, a trailing edge and a portion accommodated in the opening; a controller that rotates the vane and moves the portion of the fin; so as to keep a variation in a C/D ratio below 10%, the ratio being between a projection in a direction of projection normal to the first direction of a: length C between the leading edge and the leading edge of the fin; and length D between the leading edge and the trailing edge of the vane.

### TECHNICAL FIELD OF THE INVENTION

The present invention is concerned with the field of aeronautics and in particular with the field of variable stator vanes for aircraft turbomachines.

A first aspect of the invention relates to a setting device for a variable stator vane. A second aspect of the invention is directed to a straightener stage comprising the setting mechanism according to the first aspect of the invention. A third aspect of the invention relates to an aircraft compressor comprising a straightener stage according to the second aspect of the invention.

### TECHNOLOGICAL BACKGROUND OF THE INVENTION

An aircraft turbomachine conventionally includes a compressor, a combustion chamber and a turbine. The role of the turbine is to ensure rotatable drive of the compressor by taking some of the pressure energy from the hot gases leaving the combustion chamber and converting it into mechanical energy.

An axial compressor consists of a rotating part, the rotor, a fixed part, the stator, and an envelope, the casing, with the stator and casing integral with each other. The rotor comprises a drum made up of an assembly of several discs to which movable vanes are fastened in a circumferential row. The stator is made up of a plurality of vanes fastened to the casing or to shrouds in a circumferential row, referred to as fixed vanes (because they do not rotate about the axis of rotation but can be rotatably movable along their specific axis). Each row of fixed vanes of the stator, said to be straightening vanes, forms a straightener. A row of movable vanes and a row of fixed vanes form a compressor stage.

In a compressor, to optimise efficiency of the turbomachine and the pumping margin according to the regime, one or more rows of straightening vanes can have a variable setting angle, i.e. the angle of attack of these vanes varies according to the flight conditions. A stage of this type comprises an annular row of Variable Stator Vanes (VSVs) which are carried by the outer annular casing, usually of a compressor of the turbomachine. The angular setting of the stator vanes in a turbomachine is designed to adapt geometry of the compressor to its operating point and especially to optimise efficiency and pumping margin of this turbomachine and to reduce its fuel consumption in different flight configurations.

Each of these blades is rotatably displaceable about its axis between a first “opening” or “full opening” position, in which each blade extends substantially parallel to the longitudinal axis of the turbomachine, and a second “closing” or “quasi-closing” position, in which the vanes are tilted relative to the axis of the turbomachine and thus reduce the cross-sectional area for air to pass through the vane stage.

One technique for improving efficiency of turbomachines comprises the use of fins to reduce secondary air flows. For example, such secondary air flows can take the form of vortices at the connection between a vane blade and its plate. An example of the use of this technique in the presence of variable vanes is illustrated in FIG. 1 and described in patent application WO 2021/069817 A1 filed by the applicant.

FIG. 1 illustrates a vane 114 including a blade 112 radially extending from a plate 116 along the main axis of the vane 114. The vane 114 has variable setting and can pivot about its main axis. As can be seen, during operation of the turbomachine, air circulation in the stream produces disturbances 132 at the connection between the blade 112 and the plate 116.

The disturbances 132 take the form of vortices which grow along the flow direction, from upstream to downstream, becoming more significant when approaching the trailing edge 126 of the blade 112. The use of a radially extending fin 134 makes it possible to limit expansion of disturbances 135 downstream 136.

In the known solution illustrated in FIG. 1, however, the fins are directly integrated into the plate 116 of the variable setting vane. It follows that when the stator vane setting varies, the axial position of the fin 134 also varies. In particular, the fin 134 passes upstream of the leading edge of the vane blade 112 for large settings (pitches), making the fin 134 ineffective.

No technical solution is known today for making a variable stator vane with fins capable of improving air flow for all stator vane settings.

### SUMMARY OF THE INVENTION

The invention provides a solution to the problems discussed previously, by providing a device for setting a variable stator vane which allows both the orientation and position of a fin to be varied. In particular, the invention makes it possible to adapt position and orientation of the fins to the setting position of the vane, while optimising air flow to reduce formation of vortices near the base of the vane.

A first aspect of the invention is directed to a variable stator vane setting device for an aircraft turbomachine, said setting device comprising:
a pivotable stator vane comprising:
a stator vane base and
a vane blade extending along a first direction between the base and a top, said blade being delimited along a second direction by a leading edge and a trailing edge;
a vane pivot shaft rotatably integral with the vane, having an axis of rotation extending along the first direction and
a fin extending along a direction parallel to the first direction and being delimited along a third direction by a fin leading edge and a fin trailing edge;
the setting device being characterised in that it comprises:
a port located in the stator vane base:
a portion of the fin comprising a part housed in the port;
a control means rotatably driving the vane pivot shaft between a first angular position and a second angular position and displacing the fin portion between a first position corresponding to the first angular position and a second position corresponding to the second angular position;
so that a variation in a ratio of a length C to a length D is less than 10%, D being the projected value of the distance between the leading edge of the blade and the leading edge of the vane along a projection direction (X) normal to the first direction, C being the projected value along the projection direction (X) of the distance between the leading edge of the blade and the trailing edge of the blade.

By variation of the C/D ratio, it is meant the variation of said ratio between the first angular position and the second angular position. This variation is calculated as the difference between the value of the C/D ratio in the first angular position and the value of the C/D ratio in the second angular position, the difference then being normalised by the value of the C/D ratio in the first or second angular position.

Indeed, by keeping the ratio of C to D by projection along a projection direction normal to the first direction, the vane keeps its orientation relative to the leading edge of the vane, thereby optimising its role in reducing secondary air flows, regardless of the orientation of the vane. The projection direction is, for example, the air flow direction in the aircraft turbomachine.

The setting device according to the first aspect of the invention can be applied, for example, to a grating of variable stators, between which fins are positioned, the fins being attached to the hub or to the casing.

The fins make it possible to limit through-flow and improve the flow close to the hub or casing. This limits stall on vanes and improves stator operability.

It is noticed that it is difficult to integrate fins on a variable setting statoric ring taking aerodynamic specifications into account. These stators comprising the statoric ring and the vanes with these variable setting fins are used in many axial compressors to pre-orient flow in the first stages of the compressor.

The setting device according to the first aspect of the invention delivers a means of integrating fins so that they adapt to the setting of the stator grating. The system directly follows the stator setting while retaining the main positioning and orientation parameters required to have effective vanes in any stator vane setting position.

By angular position, it is meant a position of the vane pivot shaft corresponding to a given setting of the variable stator vane. For example, the first position may be a “full opening” position in which the vane is substantially parallel to the air flow direction in the turbomachine and the second position may be a “full closing” position wherein the vane is tilted relative to the air flow direction in the turbomachine so as to reduce the air cross-sectional area.

By projection direction, it is meant a direction normal to the radial direction along which the stator vane extends. For example, the projection direction is the air flow direction in a straightener stage comprising a setting mechanism according to the first aspect of the invention.

In addition, the setting device according to the invention makes it possible to modify the relative position of the fin and the vane in order to keep the C/D ratio constant at each setting of the stator vane and to optimise air flow near the base of the stator vane. This is possible by virtue of the fin portion housed in the port of the vane base guiding sliding of the slide connection. Each time the control ring is rotated to modify the stator vane setting, the edges of the port translationally guide the fin, which therefore modifies its position by virtue of sliding of the slide connection.

The setting device according to the first aspect of the invention therefore makes it possible to set the relative orientation of the fin and the vane and also to set the C/D ratio. These two conditions make it possible to optimise air flow for any stator vane setting between the full opening and full closing positions.

In other words, the setting system according to the first aspect of the invention sets the relative position of the grating fronts between the fin and the stator grating.

In addition, the angle of the leading edge of the fin relative to the angle of the leading edge of the stator vane is preserved.

When using the setting device according to the first aspect of the invention, the leading edge of the fin does not go upstream of the leading edge of the stator, unlike patent WO202169817 A1.

The fins integrated using the system according to the first aspect of the invention thus improve performance of variable stators and increase operability of these stator gratings. The result is a compressor with an extended and more efficient operating range.

Advantageously, the setting device comprises:
a fin pivot shaft radially extending along a direction parallel to the first direction and having an axis of rotation parallel to the axis of rotation of the vane pivot shaft;
a slide connection connecting the fin pivot shaft and the fin;
said fin pivot shaft being rotatably integral with the slide connection, the slide connection allowing sliding of the fin portion in the port upon rotating the vane pivot shaft.

The fin pivot shaft is rotatably integral with an element of the slide connection, the slide connection thus comprises a further element which is slidable relative to the element integral with the fin pivot shaft and which is guided by the fin portion housed in the port, so as to keep the ratio of the length C to the length D constant independently of the angular position of the control ring and the vane pivot shaft, in order to improve air flow.

According to one embodiment, the control means comprises a control ring having an angular position, said control ring rotatably driving the vane pivot shaft and the fin pivot shaft. By virtue of the control ring rotatably driving both the vane pivot shaft and the fin pivot shaft, the relative orientation of the stator vane and the fin is fixed. This allows a relative angle to be selected between the fin and the vane which minimises vortex formation and keeps this relative angle constant for all vane settings.

According to another embodiment, the control means comprises a second control ring connected to the fin pivot shaft.

Advantageously, the slide connection comprises:
A linking element rotatably integral with the fin pivot shaft and extending from the fin pivot shaft;
A branch integral with the fin portion and slidable inside the linking element.

The linking element allows sliding of the slide connection relative to the fin pivot shaft while rotatably securing the slide connection and the fin pivot shaft.

Advantageously, the slide connection extends along a direction normal to the axis of rotation of the fin pivot shaft. This arrangement makes it possible to change the position of the vane without changing its radial position.

Advantageously, the fin portion housed in the port extends from the slide connection to a fin body along a direction parallel to the axis of rotation of the fin pivot shaft. This arrangement makes it possible to change the position of the fin without changing its radial position.

Advantageously, the axis of rotation of the fin pivot shaft is offset relative to the axis of rotation of the blade pivot shaft. This arrangement makes it possible to modify the relative position of the fin and the stator vane to keep the C/D ratio constant.

Advantageously, the port has a curved, for example an arc of circle, shape.

Advantageously, the setting device according to the first aspect of the invention may comprise a plurality of variable stator vanes, a plurality of fins, a plurality of vane pivot shafts and a plurality of fin pivot shafts, the control means rotatably driving the plurality of stator pivot shafts. This arrangement makes it possible to obtain a statoric ring with a plurality of vanes in which the same control ring modifies setting of all the blades and of all the fins associated with the vanes, while preserving the geometric restrictions on each vane/fin pair.

A second aspect of the invention is directed to a straightener stage comprising a statoric ring and a setting device according to the first aspect of the invention, the setting device comprising a multiplicity of variable stator vanes, the variable stator vanes being distributed over the circumference of the statoric ring, the projection direction being the air flow direction in the straightener stage.

Advantageously, the setting device according to the first aspect of the invention is positioned at the casing or at the hub of the straightener stage according to the second aspect of the invention.

A third aspect of the invention is directed to an aircraft turbomachine comprising a straightener stage according to the second aspect of the invention.

The invention and its different applications will be better understood upon reading the following description and upon examining the accompanying figures.

### BRIEF DESCRIPTION OF THE FIGURES

Further advantages and characteristics of the invention will become apparent upon reading the following description, illustrated by the figures in which:

FIG. 1 illustrates a variable stator vane according to the state of the art;

FIG. 2 schematically illustrates connections of one embodiment of a stator vane setting device according to the first aspect of the invention relative to a statoric ring;

FIG. 3 illustrates a ratio of the lengths of a blade and a fin of the vane setting device in two angular positions.

FIG. 4a illustrates a three-dimensional view of an example of a setting device in a first position relative to a casing of a straightener stage.

FIG. 4b illustrates the setting device of FIG. 4a in a second position different from the first position.

FIG. 5 illustrates a three-dimensional view of a section of a straightener comprising an example of a setting device.

### DETAILED DESCRIPTION

An exemplary embodiment of a device for setting a compressor or turbomachine variable vane according to the first aspect of the invention is described hereinafter. This example illustrates the characteristics and advantages of the invention.

Unless otherwise specified, a same element appearing in different figures has a single reference.

For the purposes of understanding the invention, the orientations radial R, tangential T and axial A will be adopted according to the reference frame RTA indicated in the figures, whose tangential T and axial A axes extend in a horizontal plane along the orientation shown in the figures. The axial axis A is parallel to an axis of rotation X of an aircraft turbomachine comprising the vane setting device according to the first aspect of the invention. The upstream side of the leading edge of the variable vane towards the downstream side of the variable vane is oriented along the axial axis of the reference frame RTA. Furthermore, the term longitudinal will be used for the direction extending along the periphery of a straightener stage comprising the setting device according to the first aspect of the invention, by analogy with the terminology used in cylindrical coordinate systems of reference frames.

In the description, the terms “upstream” and “downstream” are defined relative to the air flow direction from the air inlet to the turbomachine to the air outlet from the turbine.

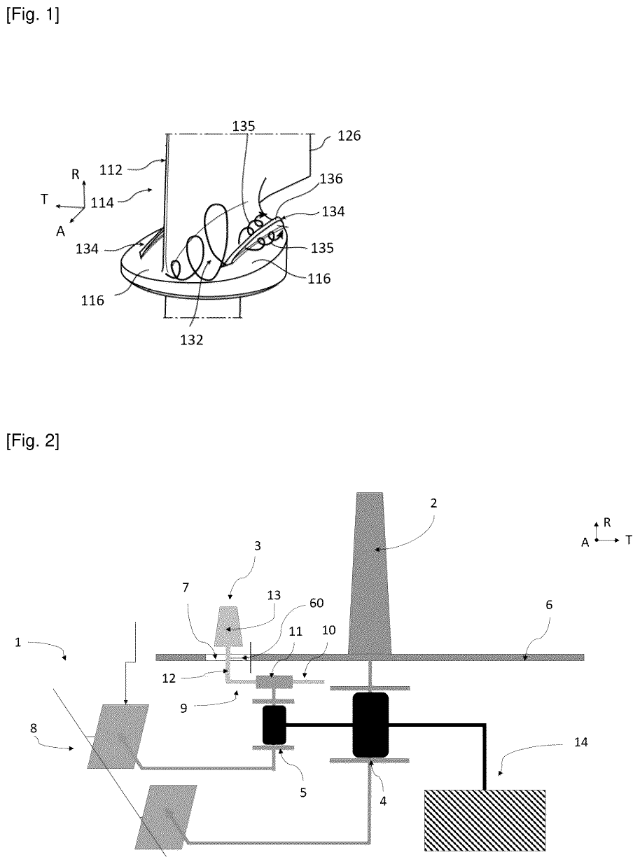

FIG. 1 has been described in relation to the state of the art.

FIG. 2 illustrates an embodiment of a device for setting 1 a variable stator vane for an aircraft turbomachine.

The setting device 1 according to the example in FIG. 2 comprises:
a variable stator vane comprising:
   a stator vane blade 2 radially extending along a first direction and
   a stator vane base 6 rotatably integral with the blade 2 and comprising a port 7;
a vane pivot shaft 4 rotatably integral with the base 6, the vane pivot shaft 4 having a first axis of rotation parallel to the first direction. Herein, the first axis of rotation is coincident with the first direction (same axis).

The setting device 1 according to the example illustrated in FIG. 2 further comprises:
a fin 3 comprising a fin body 13 and a fin portion 12 comprising a part housed in the port 7;
a fin pivot shaft 5 having an axis of rotation parallel to the first axis of rotation;
a slide connection 9 connecting the fin pivot shaft 5 and the fin 3, the connection being rotatably integral with the fin pivot shaft 5, such that rotation of the fin pivot shaft 5 slides the fin portion 12 in the port 7 relative to the base 6;
a control ring 8 connected to the vane pivot shaft 4 and to the fin pivot shaft 5 so as to rotatably drive them simultaneously.

The fin pivot shaft 5 and the vane pivot shaft 4 are each to be mounted in a first and second bearing respectively, the two bearings have an embedding connection 14 as represented in FIG. 2. The two bearings are integrated into a statoric ring that can be fastened to a casing or hub of the turbomachine.

According to the embodiment illustrated in FIG. 2, the slide connection comprises a linking element 11 accommodating a branch 10, the branch 10 sliding in the linking element 11.

In this embodiment, the slide connection 9 is perpendicular to the axis of rotation of the fin pivot shaft 5, in other words the branch 10 extends along a direction normal to the axis of rotation of the fin pivot shaft 5, enabling it to slide in the linking element 11.

The fin portion 12 housed in the port 7 extends in a direction parallel to the axis of rotation of the fin pivot shaft 5, so as not to modify radial position of the fin body 13 upon changing setting of the vane.

According to one example of the setting device 1 according to the first aspect of the invention, the base 6 of the stator vane may comprise a silicone skirt at the port 7 housing the fin portion 12. This makes it possible to limit interaction of air with the port 7 and therefore reduce aerodynamic losses.

Thus the variable setting device allows the fin 3 to be integrated at the platform of a variable stator vane and the method of integration allows it to pivot whilst preserving the relative angle to the stator grating whilst maintaining a constant relative axial position to the stator grating.

In other words, the setting device 1 is characterised by:
The vane pivot shaft 4 (also referred to as the main shaft) under the stator variable setting base 6 allowing the vane blade 2 to pivot.
The assembly of the vane pivot shaft 5 (also referred to as the secondary shaft) and the slide 9 attached to the fin 3 and to the fin pivot shaft 5, for simultaneously acting on the angular orientation and axial position of the fin.

The two axes of rotation of the pivot shafts are fixed by virtue of an embedding type connection 14.

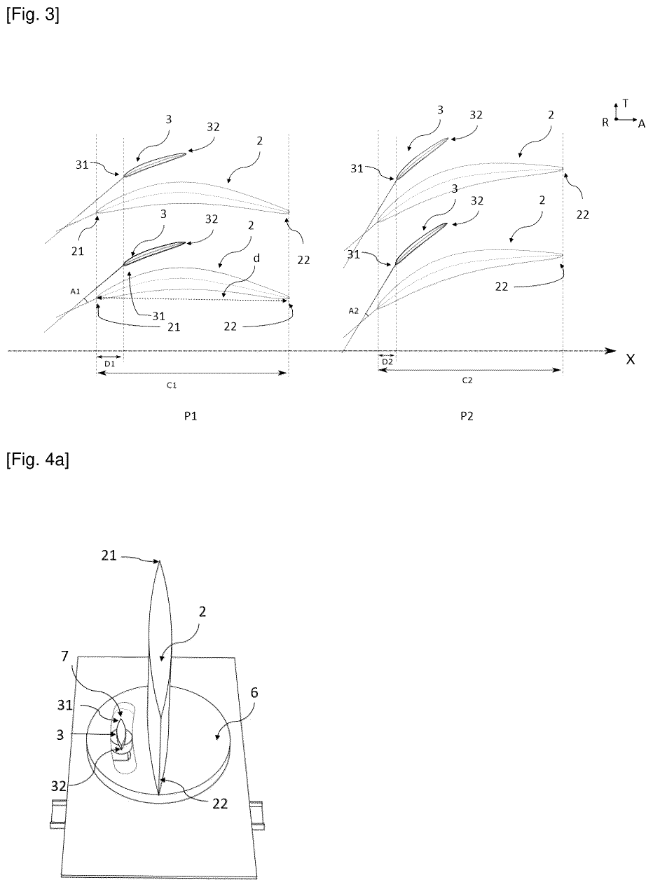

The drives of the vane or main pivot shaft 4 and the fin or secondary pivot shaft 5 are connected in such a way as to comply with the relative fin/stator blade positioning restrictions, in terms of angle and axial position, illustrated in FIG. 3.

FIG. 3 shows two positions of the fin 3 relative to the blade 2 of the setting device 1 according to one example of the first aspect of the invention to show the simultaneous course of the setting of the stator blades and fins. In particular, FIG. 3 illustrates the position of the vane blades 2 and fins 3 for two possible stator vane settings, P1 and P2.

Each vane blade 2 is delimited along a projection direction X normal to the axis of rotation by a leading edge 21 and a trailing edge 22. The projection direction X is, for example, parallel to the axis of rotation of the turbomachine.

Similarly, each fin 3 is delimited by a fin leading edge 31 and a fin trailing edge 32.

According to one embodiment, the projection direction X is the air flow direction in the turbomachine.

Whatever the position of the stator, the device 1 according to the first aspect of the invention makes it possible to preserve the ratio of the projected value D along the projection direction X of the distance separating the leading edge of the stator vane 21 and the leading edge of the fin 31 to the projected value C along the projection direction X of the stator chord. Whatever the setting angle, D/C is preserved, i.e. D1/C1=D2/C2.

The projected value of the stator chord is equivalent to the projected value of the distance d separating the leading edge 21 from the trailing edge 22.

The variable setting device further preserves the relative angle between the orientation of the backbone at the stator leading edge and the orientation of the backbone at the fin leading edge, namely A1=A2.

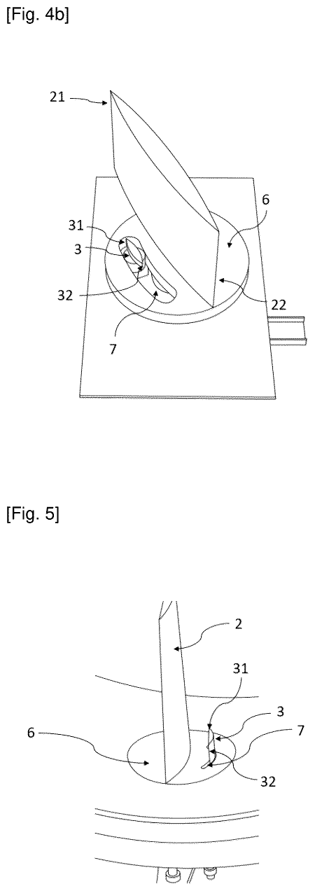

As illustrated in the examples in FIGS. 4a, 4b and FIG. 5, the device 1 is integrated with the variable stator and is operated by the same control ring as the stator setting. The fin pivot shaft 5, which is eccentric relative to the fin axis, enables the required range of movement to be achieved. The slide 9 allows the variation in distance between the fin 3 and its pivot shaft 5 to be corrected.

According to one embodiment, the setting device comprises a multiplicity of stator vanes and fins. The stator vanes and fins are distributed over a circumference to form a statoric ring.

A second aspect of the invention is directed to a straightener stage comprising a statoric ring and the setting device 1 according to one aspect of the invention. The statoric ring comprises a plurality of openings each housing a base 6.

According to one embodiment, the statoric ring is radially external to the blade 2 of the setting device. In this case, the statoric ring may be part of a casing or be fastened to the casing of the turbomachine.

According to another embodiment, the statoric ring is radially internal to the setting device. In this case, the statoric ring can be part of a hub or fastened to the hub of the turbomachine.

FIG. 4a and FIG. 4b illustrate an application of the setting device 1 with a large port 7 to house a portion of the fin 3, so as to facilitate viewing of the setting device 1. In this case, the fin 3 is positioned at the hub. In other words, the statoric ring is radially internal to the blade 2 of the setting device and external to the slide connection and the vane and fin pivot shafts 4 and 5 respectively. FIG. 4a shows a first setting (first angular position) P1 of the stator blade 2 relative to the statoric ring and a position of the fin 3 relative to the stator vane. FIG. 4b shows a second setting P2 of the blade 2. The fin 3 can move forwards or backwards to preserve its relative position to the blade 2 and keeps the same relative angle throughout the movement.

FIG. 5 illustrates another embodiment of the setting device 1 according to the first aspect of the invention. This time, the setting device is positioned on the casing. In other words, the statoric ring is radially outer relative to the setting device 1. In addition, as previously explained, the port 7 is thinner, to limit effects of its aerodynamic interaction with the flow.

According to this embodiment illustrated in FIG. 5, the cross-sectional area of the fin portion 12 is smaller than the cross-sectional area of the fin body 13. This reduces the width of the port 7 housing the fin portion 12 and therefore limits the interaction of air with the edges of the port 7.

According to one alternative of the setting device 1, it is possible to vary the distance between the vane pivot shaft 4 and the fin pivot shaft 5. This is advantageous in the case where the optimum position of the fin 3 varies according to the setting of the stator vane 2 and the optimum position of the fin 3 is therefore not the same for two different settings of the stator vane.

1. A device for setting a variable stator vane for an aircraft turbomachine, said setting device comprising:
a pivotable stator vane comprising:
a stator vane base and
a vane blade extending along a first direction between the base and a tip, said blade being delimited in a second direction by a leading edge and a trailing edge
a vane pivot shaft rotatably integral with the vane, having an axis of rotation extending along the first direction and
a fin extending along a direction parallel to the first direction and being delimited along a third direction by a fin leading edge and a fin trailing edge;
a port located in the stator vane base
a portion of the fin comprising a part housed in the port
a control means rotatably driving the vane pivot shaft between a first angular position and a second angular position and displacing the portion of the fin between a first position corresponding to the first angular position and a second position corresponding to the second angular position;
so that a variation of a ratio of a length C to a length D is less than 10%, D being the projected value of the distance between the leading edge of the blade and the leading edge of the fin along a projection direction (X) normal to the first direction, C being the projected value along the projection direction of the distance between the leading edge of the blade and the trailing edge of the blade.

2. The setting device according to claim 1, comprising:
a fin pivot shaft radially extending along a direction parallel to the first direction and having an axis of rotation parallel to the axis of rotation of the vane pivot shaft
a slide connection connecting the fin pivot shaft and the fin
said fin pivot shaft being rotatably integral with the slide connection the slide connection allowing sliding of the fin portion in the port upon rotating the fin pivot shaft

3. The setting device according to claim 2, wherein the slide connection comprises:
a linking element rotatably integral with the fin pivot shaft and extending from the fin pivot shaft
a branch (10) integral with the portion of the fin and slidable inside the linking element

4. The setting device according to claim wherein the slide connection extends along a direction normal to the axis of rotation of the fin pivot shaft

5. The setting device according to claim 2 wherein the fin portion housed in the port extends from a branch of the slide connection to a fin body along a direction parallel to the axis of rotation of the fin pivot shaft

6. The setting device according to claim 2 5, wherein the axis of rotation of the fin pivot shaft is offset relative to the axis of rotation of the vane pivot shaft

7. The setting device according to claim 1 preceding wherein the port has an arc of circle shape.

8. The setting device according to claim 1 comprising a plurality of variable stator vanes, a plurality of fins, a plurality of vane pivot shafts and a plurality of fin pivot shafts, the control means rotatably driving the plurality of stator pivot shafts.

9. A straightener stage comprising a statoric ring and a setting device according to claim 8, the variable stator vanes being distributed over the circumference of the statoric ring, the projection direction being the air flow direction in the straightener stage.

10. An aircraft turbomachine comprising a straightener stage according to claim 9.
